(19) United States
(12) Patent Application Publication
(10) Pub. No.: US 2009/0189507 A1
(43) Pub. Date: Jul. 30, 2009

(54) Process for the preparation of garnet phosphors in a pulsation reactor

(76) Inventors: Holger Winkler, Darmstadt (DE); Tarek Khalil, Weimar (DE); Gerd Fischer, Osnabrueck (DE); Lars Leidolph, Erfurt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/304,313

(22) PCT Filed: May 21, 2007
(86) PCT No.: PCT/EP07/04488

§ 371 Date: Dec. 11, 2008

(30) Foreign Application Priority Data
Jun. 12, 2006 (DE) 10 2006 027 133.5

(51) Int. Cl. H01J 63/04; C09K 11/77; H01J 1/62

(52) U.S. Cl. 313/484; 252/301.4 R; 313/483

(57) ABSTRACT

The invention relates to a process for the preparation of garnet phosphors or precursors thereof having particles with an average particle size of 50 nm to 20 μm via a multistep thermal process in a pulsation reactor, and to illumination units comprising the garnet phosphors according to the invention.

The invention relates to a process for the preparation of garnet phosphors or precursors thereof having particles with an average particle size of 50 nm to 20 μm via a multistep thermal process in a pulsation reactor, and to illumination units comprising the garnet phosphors according to the invention.

The term “garnet phosphors” is taken to mean ternary crystalline compositions having a cubic garnet structure, such as, for example, Y₃Al₅O₁₂ (YAG), which may be doped, for example, with cerium.

In pcLEDs (phosphor converted LEDs), YAG:Ce³⁺ is employed as down-conversion phosphor in order to convert part of the blue electroluminescence from the InGaN chip (wavelength 450-470 nm) into yellowish light (broad fluorescence band having a maximum in the range from about 540 nm-580 nm) by photoluminescence. The yellow light and the residual transmitted blue light add up to white light, which is emitted by the pcLED. This wavelength conversion phosphor consists of a host lattice comprising crystalline cubic YAG (Y₃Al₅O₁₂), in which lattice positions of the yttrium have been substituted by cerium. The degrees of Cer³⁺ doping are usually 0.05 atom-% to 5.0 atom-%, based on yttrium (typically:

### [Y_{0.98}Ce_{0.02})₃Al₅O₁₂].

The degree of doping has a pronounced influence on the intensity (see P. J. Yia, Thin Solid Films, 2005, 483, pages 122-129) and the position of the fluorescence band in YAG:Ce³⁺ phosphors (according to T. Jüstel, presentation at the Global Phosphor Summit, 2006: a higher Ce³⁺ concentration results in a red shift of the emission, but also in an increase in thermal quenching of the emission from the phosphor).

In the case of the YAG:Ce phosphor, there are strong interactions between the host lattice (YAG) and the activator Ce³⁺, which is reflected in a broad photoluminescence band.

Ce³⁺ has the electron configuration [Xe]4f¹. The optical transitions in the VIS which are relevant to the phosphor occur between the 4f¹ level and the higher 5d¹ level. The position of the d energy levels is significantly affected by the influence of the crystal field of the cubic YAG lattice: firstly, the nephelauxetic effect occurs, i.e. the energy of the d orbitals of the Ce³⁺ is reduced compared with the free cerium ion. Furthermore, the crystal field results in splitting of the d orbitals of the cerium. This has the consequence that 4f electrons (²F_{5/2}) of the cerium are promoted into the 5d orbitals (²D) by absorption of blue light. From there, the electrons fall back to 4f (²F_{7/2} or ²F_{5/2}). During this, the Stokes shift decrees that not all the energy is released as light, but instead is partly emitted as heat via loss processes in the form of vibrations. The emitted radiation is consequently in the greenish-yellow to yellow-pale orange part of the visible spectrum.

The position and splitting of the d levels of the Ce³⁺ can be influenced by the incorporation of suitable foreign ions into the YAG lattice. Thus, (partial) substitution of the yttrium in the YAG by trivalent gadolinium and/or terbium shifts the emission band towards red compared with pure YAG:Ce. This occurs since these ions, which are smaller than trivalent yttrium, compress the lattice, reducing the average separation between the cerium ions and the oxygen anion (ion radii: Y³⁺: 106 nm, Gd³⁺: 97 nm, Tb³⁺: 93 nm, Ce³⁺: 107 nm, Ce⁴⁺: 94 nm). A greater crystal-field strength thus prevails at the cerium ion, and the 5d orbitals are split to a greater extent. Ultimately, the energetic separation between the 5d and 4f orbitals is thus reduced, and the emission shifts towards red.

By contrast, (partial) substitution of aluminium (3+) by gallium (3+) or of yttrium (3+) by lanthanum (3+) results in a blue shift of the emission band (ion radii: Ga³⁺: 62 nm, Al³⁺: 57 nm, Y³⁺: 106 nm, Lu³⁺: 122 nm). This occurs due to the incorporation of the larger ions, causing an increase in the aver-age cerium-oxygen separation and consequently a smaller crystal-field strength to prevail at the cerium. As a consequence, the 5d orbitals of the cerium are split to a lesser extent, and the energy separation between the 4f and 5d levels becomes greater, which is in turn associated with the blue shift of the emission.

The efficiency of the given stoichiometry of the phosphor depends essentially on the following factors:

The phosphor should absorb the highest possible percentage of the light available for excitation (in the case of YAG:Ce and analogous derivatives formed by substitution, the highest possible percentage of the blue radiation from the LED (wavelength about 450-470 nm) should be absorbed). The absorption may be made more difficult and reduced if the phosphor transmits too much light (i.e. excessively thin phosphor layer) and/or too much light is reflected or scattered in a diffuse manner at the surface of the phosphor. In order to minimise reflection/scattering, the surface area of the phosphor should be as small as possible, i.e. non-porous particle surfaces. Scattering effects can be observed to a particularly great extent in the case of extremely fine particles with a diameter of less than the wavelength of the scattered light. However, if the particle size becomes very much smaller than the wavelength, the intensity of the scattering decreases again (this applies for particles <20 nm in the case of VIS light). Furthermore, the scattering by micron-sized, non-porous particles with a small surface area can be effectively reduced by coating with a layer whose refractive index is matched to the environment [refractive index of YAG:Ce=1.82, refractive index of the embedding medium (silicones, epoxy resins) 1.4 . . . 1.6]. The degree of absorption of a phosphor should be >60%. It should be taken into account here, however, that a certain proportion of the blue excitation light from the electroluminescent LED chip must be transmitted by the phosphor or phosphor layer in order to generate white light through additive colour combination. The scattering at the phosphor surface should be as low as possible. If the scattered light reaches the LED chip again, it is absorbed there (there is no Stokes shift for the semiconductor chip, i.e. absorption wavelength=emission wavelength) and is no longer available.

As soon as the exciting light has penetrated into the phosphor to a large extent and has been absorbed by the activator (Ce³⁺), the excitation light must be converted into fluorescent radiation as completely as possible. The extent of this conversion is described by the so-called internal quantum efficiency (QE, in.). However, some quanta of the excitation radiation are lost due to loss processes, meaning that less than 100% of the photons are emitted. The aim is for QE, in. to be >80%.

This can be achieved through all activators being located in a very homogeneous and suitable crystal field. This requires perfect high-quality crystallinity of the matrix lattice. In addition, the activators must be homogeneously distributed in the interests of a high internal quantum efficiency. Concentration gradients result in a reduction in the concentration to zero. Finally, harmful foreign ions, such as heavy metals, may only be present in a few 10 ppm as impurity. This also applies to carbon impurities.

For high crystal quality, garnet particles in a size range from several hundred nm to 2 μm are necessary. In the case of smaller particles, too many activator ions are located on the surface, characterised by crystal formation errors and interfering adsorbates. A remedy for this can be provided if the particle is sheathed with suitable materials (for example sheathing with undoped matrix).

In addition, the energy of the emitted photons is lower than the energy of the absorbed photons since loss processes again occur here, such as, for example, thermal de-excitation by lattice vibrations (phonons).

Finally, the highest possible proportion of the fluorescent light formed in the phosphor must be coupled out of the phosphor, which may be made more difficult by total internal reflection. The total internal reflection can likewise be reduced by coating the phosphor surface with material of matched refractive index. In particular in the case of very small nanoparticles comprising YAG:Ce, light scattering plays only a minor role. In such cases, however, coating of the phosphor must be used in order to prevent a reduction in the photoluminescence efficiency (“luminescence quenching”) by phonon events, i.e. de-excitation of the activator via matrix-promoted vibrations.

Luminescence quenching generally takes place preferentially through high densities of surface defects of excited nanoparticles or at adsorbed hydroxyl surface groups and water molecules. Thin coatings on the surface of nanophosphors can act as insulators for phonons.

Surface coatings of phosphor particles comprising YAG:Ce can be carried out by sol-gel reactions with precursors (for example alkoxides) for, for example, silicon dioxide or aluminium oxide. Most amorphous layers are produced by base- or acid-catalysed hydrolysis, followed by condensation of the precursors.

In the prior art, YAG:Ce phosphors are prepared by diffusion-controlled solid-state reactions at high temperatures (>1600° C.), which are maintained for up to more than 20 h. As starting materials, macroscopic oxide powders of the individual components (yttrium oxide, aluminium oxide and cerium oxide) are mixed and reacted thermally in a furnace. Since the starting materials merely represent a coarse distribution of the reactants, diffusion processes are the only processes which enable material transport for the solid-state reaction.

The resultant reaction products are determined by an inhomogeneous composition, partially unreacted regions (i.e. deviation from the target composition), uncontrollable morphology and uncontrollable particle-size distribution. In addition, the said quantities can only be reproduced with difficulty from batch to batch.

Since the area above the LED chip is very small (max. 1 mm²), only a small amount of phosphor can be employed in the LED, which, however, makes very high quality demands of the phosphor in relation to its optical properties, constancy of the properties and reproducible and targeted integration into the LED.

Very generally, garnet phosphors can be prepared by the following processes:

mixing, drying and subsequent thermal decomposition of oxides, carbonates, nitrates, acetates, chlorides or other salts; coprecipitation and subsequent drying and calcination; sol-gel technique; hydrolysis of alkoxides; plasma spraying process; spray pyrolysis of aqueous or organic salt solutions.

Spray pyrolysis is one of the aerosol processes, which are characterised by spraying of solutions, suspensions or dispersions into a reaction space (reactor) heated in various ways and by the formation and deposition of solid particles. In contrast to spray drying with hot-gas temperatures <200° C., thermal decomposition of the starting materials used (for example salts) and the re-formation of substances (for example oxides, mixed oxides) take place in addition to evaporation of the solvent as high-temperature process in spray pyrolysis.

Due to differences in heat generation and transfer, the supply of energy and feed product, the type of aerosol production and the type of particle deposition, there is a large number of process variants, which are also characterised by different reactor designs:
Hot-wall reactor: externally electrically heated tube, optionally with separately controllable heating zones; low energy input at the spray-in point (see WO 2006/087061 (Merck))
Flame pyrolysis reactor: energy and hot-gas production by means of reaction of fuel gas (for example hydrogen) with oxygen or air; spraying directly into the flame or into the hot combustion gases in the region close to the flame; very high energy input at the spray-in point
Hot-gas reactor: hot-gas production by
   electric gas heater (introduction of the aerosol into the carrier gas; variable, but usually limited (low) energy input at the spray-in point
   flameless, pulsating combustion of hydrogen or natural gas with air in a pulsation reactor; energy input at the spray-in point which can be controlled in a broad range; pulsating gas flow with high degree of turbulence (see WO 02/072471 (Merck))

The following process variants are described in the literature:

WO 02/072471 (Merck) describes a process for the preparation of multinary metal-oxide powders for use as precursors for high-temperature supraconductors, where the corresponding metal-oxide powders are prepared in a pulsation reactor and contain at least three elements selected from Cu, Bi, Pb, Y, Tl, Hg, La, lanthanides, alkaline-earth metals.

DE 102005002659.1 (Merck, date of filing: 19.01.2005) describes how mixed-oxide powders consisting of compact, spherical particles can be prepared by a specific process design in a pulsation reactor. In order to carry out this process, the starting solutions are sprayed into a hot-gas stream generated by pulsating, flameless combustion.

DE 102005007036.1 (Merck, date of filing: 15.02.2005) describes a process for the preparation of spherical, binary or multinary mixed-oxide powders having average particle sizes <10 μm by spray pyrolysis, where at least two starting materials in the form of salts, hydroxides or mixtures thereof are dissolved or dispersed in water, bases or acids or are dispersed in the salt solution of one or more starting materials and a surfactant and/or inorganic salt which decomposes in an exothermic reaction is added, and this mixture is sprayed into an electrically heated pyrolysis reactor (hot-wall reactor), decomposed thermally and converted into mixed oxides.

According to JP 10338520 (Tamei Chemicals Co.), yttrium aluminium oxide powders can be prepared by spray calcination of aqueous yttrium and aluminium salt solutions, where polyaluminium chloride is preferably used as one starting material.

In summary, it should be noted that the above-mentioned known spray pyrolysis processes have the following disadvantages for the preparation of the garnet phosphors according to the invention:

The processes omit subsequent thermal treatment of the spray-pyrolysed material. These powders thus have inadequate crystallinity (high amorphous content and crystalline foreign phases) since the energy taken up in the reactor is insufficient for defined crystallisation processes within the powder formed. Furthermore, the above-mentioned processes result in a non-negligible content of porous powder of inhomogeneous morphology and broad particle-size distribution.

Crystalline secondary phases and/or amorphous components within the garnet phosphor result in a reduction in the phosphor efficiency due to a reduction in the internal quantum efficiency. An increase in the specific surface area of the garnet phosphor due to the existence of pores in the powder likewise results in a reduction in the phosphor efficiency in that less excitation light is able to penetrate into the phosphor due to increased scattering of light at the particle surface (reduction in the external quantum efficiency). Broad particle-size distributions which are inhomogeneous from batch to batch and inhomogeneous particle morphologies likewise result in a reduction in the phosphor efficiency in an LED since uniform coatings of the primary light source are thus impossible. This results, inter alia, in an inhomogeneous colour of the light cone of a phosphor converted LED.

The object of the present invention is therefore to develop a process which achieves the above-mentioned properties of the phosphors. The starting materials here should already have a homogeneous distribution at the molecular level. In particular, it should be a preparation process in which a phosphor precursor which already has the requisite reactant ratios is prepared by wet-chemical methods. This precursor should be a solution, suspension, dispersion, sol or precipitate. In a further step, this precursor should be thermally treated in the form that the precursor is converted into small, non-porous and spherical solid particles which are able to undergo a thermal reaction due to the high temperatures and may already be partially converted into the crystalline phase.

It is usually not possible to produce non-porous, spherical solid particles by means of flame spray pyrolysis. This applies in particular in the case of the use of nitrates as starting materials.

Surprisingly, however, the present object can be achieved in that a starting-material mixture which comprises at least all requisite components for the formation of the garnet phosphors is sprayed and thermally treated in a specific thermal reactor with specific temperature control, it being possible for an additional fuel addition to take place during the thermal treatment in this specific reactor at a point which is located at a downstream site in the reactor relative to the spray-in point. The intermediate resulting from this specific reactor is converted into the desired form by an additional one-step or multistep thermal aftertreatment in the same and/or a different reactor.

The present invention thus relates to a multistep thermal process for the preparation of garnet phosphors or precursors thereof having particles with an average particle size of 50 nm to 20 μm, where a mixture in the form of a solution, suspension or dispersion which comprises all components for the preparation of the garnet phosphors is sprayed by fine atomisation into a thermal reactor, where the hot-gas stream of the reactor is produced by pulsating combustion of fuel gas/air mixture, where the temperature at the spray-in point in the thermal reactor is 500-1500° C., preferably 800-1300° C., where the thermal treatment of the mixture in the thermal reactor can optionally be combined with additional feed of fuel in the thermal reactor at a site which is behind the spray-in point relative to the hot-gas stream at a downstream site, and an additional thermal aftertreatment can take place in the same and/or a different thermal reactor.

The average particle size of the particles is preferably 500 nm to 5 μm, more preferably 1 to 3 μm. In this connection, the “average particle size” is taken to mean the arithmetic mean of the spherical particle diameters recorded. This is determined by measuring the diameters of the individual particles manually based on a calibrated SEM image of the particles and determining the arithmetic mean therefrom.

The particles are preferably spherical.

Suitable starting materials for the garnet phosphor mixture are inorganic and/or organic substances, such as nitrates, carbonates, hydrogencarbonates, carboxylates, alcoholates, acetates, oxalates, citrates, halides, sulfates, organometallic compounds, hydroxides and/or oxides of Al, Y, Gd, Tb, Ga, Lu, Pr, Tb, Ga, Eu and/or Ce, which are dissolved and/or suspended in inorganic and/or organic liquids. Preference is given to the use of mixed nitrate solutions which comprise the corresponding elements in the requisite stoichiometric ratio.

A solution, suspension or dispersion which comprises at least all components of the desired garnet phosphor composition in the stoichiometric ratio is prepared from the starting materials.

The thermal treatment according to the invention of this raw-material mixture in a specific type of reactor results in the formation of solid particles without the formation of sintered products. This is carried out by bringing the starting-material mixture to the requisite thermal treatment temperature very quickly and only subjecting it to this treatment temperature for a very short time.

These requirements are achieved in accordance with the invention by the specific design of the thermal process, which comprises spraying the feed material into a hot-gas stream which is produced by the pulsating combustion (pulsation reactor) and by the setting of a specific temperature profile in this pulsation reactor.

The thermal process according to the invention for the preparation of garnet phosphors differs from the processes known from the prior art through the reactor construction, the process design, the energy transfer, the course of the reaction of the actual garnet phosphor formation. The principle of action of the pulsation reactor according to the invention is similar to that of an acoustic cavity resonator, which consists of a combustion chamber, a resonance tube and a cyclone or filter for powder deposition and represents a significant improvement over conventional spray pyrolysis. The principle of action of the pulsation reactor is described in detail in WO 02/072471 (Merck), the entire contents of which expressly belong to the disclosure of the present application.

The pulsating combustion process in a combustion chamber releases energy with the propagation of a pressure wave in the resonance tube and stimulates an acoustic vibration therein. Pulsed flows of this type are characterised by a high degree of turbulence. The pulsation frequency can be adjusted via the reactor geometry and/or through the choice of the process parameters and varied specifically via the temperature. This presents the person skilled in the art with absolutely no difficulties. The gas stream resulting from the pulsating combustion preferably pulses at 3 to 150 Hz, particularly preferably at 10 to 70 Hz.

The object according to the invention consists, inter alia, in the particles produced being distinguished by a spherical shape. Through the combination of the preferred material feed (fine atomisation into the reactor) and the thermal treatment in the pulsation reactor, this object can be achieved in principle. Nevertheless, the thermal-shock-like treatment of the raw-material mixture in the pulsation reactor, especially on use of aqueous raw-material mixtures, can result in crust formation in the case of the raw-material droplets sprayed in due to evaporation at the droplet surface and the associated increase in concentration of the contents at the surface. This crust initially prevents the escape of gaseous substances formed (for example thermal decomposition of the solvents or elimination of nitrate) from the interior of the droplets. However, the gas pressure ultimately breaks the crusts, and particles with a so-called hollow-sphere structure form. However, the formation of particles with a hollow-sphere structure is undesired in the preparation of garnet phosphor powders, where a spherical shape is preferred.

However, it has been found that, in contrast to conventional spray pyrolysis processes, crust formation of this type on the particles forming can be avoided in the case of the pulsation reactor according to the invention by reducing the energy input at the spray-in point, for example by limiting the process temperature in the combustion chamber. It may initially happen here, especially in the case of industrially relevant feed throughputs, that, owing, for example, to a reduction in the process temperature in the combustion chamber in combination with the short residence times in the pulsation reactor, complete substance conversion does not take place in every case and the powders have an ignition loss of greater than 5%.

In particular on use of a reactor with hot-gas production by pulsating combustion in the form of a ramjet tube (pulsation reactor), however, the introduction of an additional amount of fuel gas (natural gas or hydrogen) enables the energy input to be increased at the point in time when, for example, solvent is no longer present in the interior of the particles. This energy serves, for example, to thermally decompose salt residues still present and to accelerate or complete the substance conversion, for example phase formation. The feed of the reaction gas takes place in accordance with the invention after 20-40%, preferably 30%, of the total residence time of the substances in the reactor.

The possibility of reducing the process temperature at the spray-in point and additional firing at a downstream point (relative to the hot-gas stream) in the process enable the preparation of spherical particle shapes in the pulsation reactor, in contrast to the case in known spray pyrolysis processes, even on use of, for example, aqueous starting solutions, at the same time as desired substance conversion. The use that is thus possible of, for example, aqueous starting solutions, especially in combination with nitrates as starting materials, represents an important economic advantage.

The shape and in particular the particle size crucially determine the product properties of the garnet phosphors. The use according to the invention of the pulsation reactor for thermal treatment of the starting solution offers the person skilled in the art a multiplicity of ways of varying the particle size by varying process parameters. Thus, for example, variation of the nozzle diameter and/or the compressed air fed to the two-component nozzle enables the droplet size during feeding into the pulsation reactor to be influenced. The same applies to the targeted control of the temperature profile and/or variation of the residence time.

Besides the variation of process parameters in the pulsation reactor, the resultant particle size can also be influenced by specifically influencing the starting solution, suspension or dispersion.

The additional addition of one or more surfactants and/or emulsifiers, for example in the form of a fatty alcohol ethoxylate, in an amount of 1 to 10% by weight, preferably 3 to 6%, based on the total amount of the solution, causes the formation of finer particles with an even more uniform spherical shape.

A particularly narrow and defined particle-size distribution can take place, for example, by a one- or multistage wet-chemical intermediate step before the thermal treatment in the pulsation reactor. To this end, the particle size can firstly be set in the starting mixture via the type and process control of the single- or multistage wet-chemical intermediate step, for example via coprecipitation. Since the particle size set in this way can be modified by the subsequent thermal process, the particle size in the starting mixture should be set in such a way that the particle size after the thermal treatment corresponds to the desired parameters. For the wet-chemical pretreatment of an aqueous and/or alcoholic precursor of the garnet phosphors consisting, for example, of a mixture of yttrium nitrate, aluminium nitrate, cerium nitrate and gadolinium nitrate solution, the following known methods are preferred:
“Coprecipitation with an NH₄HCO₃ solution” (see Journal of the Europ. Ceramic Soc. Vol. 25, Issue 9, 1565-73)
“Pechini process” (see U.S. Pat. No. 3,330,697) with a precipitation solution comprising citric acid and ethylene glycol or
“Combustion process” using urea as precipitation reagent (see P. Ravindranathan et al., Jour. of Mater. Science Letters, Vol. 12, No. 6 (1993) 369-371).

During the above-mentioned “coprecipitation”, an NH₄HCO₃ solution is added, for example, to nitrate solutions of the corresponding phosphor starting materials, resulting in the formation of the phosphor precursor.

In the “Pechini process”, a precipitation reagent consisting of citric acid and ethylene glycol is added, for example, to the above-mentioned nitrate solutions of the corresponding phosphor starting materials at room temperature, and the mixture is subsequently heated. Increasing the viscosity results in the formation of the phosphor precursor.

In the “combustion process”, the above-mentioned nitrate solutions of the corresponding phosphor starting materials are, for example, dissolved in water, then boiled under reflux, and urea is added, resulting in the slow formation of the phosphor precursor.

Besides the wet-chemical treatment steps described, the particle size and particle-size distribution can also be influenced by the preparation of an emulsion from the starting mixture. An emulsion here is taken to mean a finely divided mixture of two different (normally immiscible) liquids without visible separation. The so-called internal phase (disperse phase) is in the form of small droplets distributed in the so-called external phase (continuous phase, dispersion medium). Emulsions thus belong to the disperse systems. A further constituent of all emulsions is the emulsifier, which low-ers the energy of the phase interface and thus counters separation. For the stabilisation of immiscible liquids, interface-active substances (for example emulsifiers, surfactants) can be added; they prevent the mixture from separating back into its constituents. This so-called “breaking of the emulsion” takes place since the large interface energy is reduced by coalescence of the droplets. Surfactants reduce this interface energy and thus stabilise the emulsion.

For the preparation of the emulsion, a second component which is immiscible with the starting mixture is added to the latter. In order to input the work necessary for emulsification into the medium, there is a whole series of possible methods known to the person skilled in the art, such as, for example: high-speed stirrers, high-pressure homogenisers, shakers, vibration mixers, ultrasound generators, emulsification centrifuges, colloid mills, atomisers. The reduction in the size of the drops during preparation of an emulsion causes the phase interface between the two phases to increase. The interfacial tension must be overcome here and a new interface created. This requires work, which must be introduced into the system mechanically. The shear forces which occur in the process cause the droplets to become ever smaller. The interfacial tension can be drastically reduced by one or more emulsifiers. The emulsifier is also intended to prevent the newly formed droplets from re-coalescing. To this end, it must diffuse as quickly as possible to the new interface. Synthetic emulsifiers do this in a few milliseconds. Large emulsifier molecules, which in addition significantly increase the viscosity (for example starch), require a few minutes to half an hour in order completely to envelop the new drops. However, a higher viscosity also has a stabilising influence since the movement of the droplets and thus the possibility of coalescence is made more difficult.

In a preferred embodiment of the present invention, one or more liquid components can additionally be added to the garnet phosphor precursor consisting of a mixture, the liquid components being immiscible with this mixture, and this mixture is dispersed by means of mechanical shear forces, for example in a Niro/Soavi high-pressure homogeniser, to give droplets and stabilised by means of assistants. The liquid component which is immiscible with this mixture preferably consists of petroleum benzin having a boiling range of 80-180° C., preferably 100-140° C., and can be added in combination with an emulsifier.

The emulsifiers used can be sorbitan fatty acid derivatives or particularly advantageously a mixture thereof with a random copolymer containing at least one monomer having a hydrophilic side chain and at least one monomer having a hydrophobic side chain and a molecular weight between 1000 and 50,000, preferably between 2000 and 20,000. The ratio of hydrophobic to hydrophilic side chains here is preferably 4:1 to 2:3. A random copolymer consisting of dodecyl methacrylate and hydroxyethyl methacrylate in the ratio 1:1 to 3:1, as described in WO 2004/14389 (Merck), is more preferred.

Corresponding copolymers can be described by the general formula I

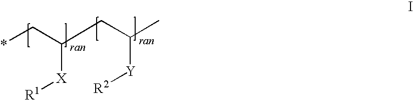

in which the radicals X and Y correspond to conventional nonionic or ionic monomers, and
R¹ denotes hydrogen or a hydrophobic side group, preferably selected from branched and unbranched alkyl radicals having at least four carbon atoms in which one or more, preferably all, H atoms may be replaced by fluorine atoms, and, independently of R¹,
R² stands for a hydrophilic side group, which preferably has a phosphonate, sulfonate, polyol or polyether radical.

Particular preference is given in accordance with the invention to polymers of this type in which —Y—R² stands for a betaine structure.

In this connection, particular preference is in turn given to copolymers of the formula I in which X and Y, independently of one another, stand for —O—, —C(═O)—O—, —C(═O)—NH—, —(CH₂)ₙ—, phenyl, naphthyl or pyridyl. Furthermore, copolymers in which at least one structural unit contains at least one quaternary nitrogen atom, where R² preferably stands for a —(CH₂)ₘ—(N⁺(CH₃)₂)—(CH₂)ₙ—SO₃⁻ side group or a —(CH₂)ₘ—(N⁺(CH₃)₂)—(CH₂)ₙ—PO₃²⁻ side group, where m denotes an integer from the range 1 to 30, preferably from the range 1 to 6, particularly preferably 2, and n stands for an integer from the range 1 to 30, preferably from the range 1 to 8, particularly preferably 3, have particularly advantageous properties in the use according to the invention.

On use of an emulsifier mixture of this type, the emulsion has improved stability (no separation within 12 hours). This results in a simplification of the technological process, in an improvement in the powder morphology and in an increase in the reproducibility of the powder properties.

In the process described in DE 4307 333, the material to be atomised is introduced into an externally, electrically heated tubular reactor or preferably directly into the region of the flame produced by combustion of a combustible gas, such as propane, butane or natural gas and (atmospheric) oxygen. A combined arrangement of gas burner and spray nozzle is mentioned therein as particularly advantageous, where the spray nozzle is preferably arranged centrally in the burner head. It is stated that maximum contact of the atomised emulsion droplets with the burner flame is thereby ensured. By contrast, the emulsion in the process according to the invention is sprayed into the hot-gas stream produced by means of pulsating combustion.

The introduction of combustible substances with the emulsion, such as petroleum ether, into the reactor can be compensated correspondingly by reduction of the feed of fuel gas to the reactor.

In the Y—Al—O:Ce system, the phase formation is influenced particularly strongly by the type of starting materials and the thermal decomposition thereof.

According to J. of Alloys and Compounds 255 (1997), pp. 102-105, it is difficult to prepare phase-pure, cubic Y₃Al₅O₁₂ (YAG), in particular by means of solid-state reaction processes. Even at calcination temperatures of 1600° C., the oxides of Al and Y and the phases YAlO₃ (perovskite phase: YAP) and Y₄Al₂O₉ (monoclinic phase: YAM) are said to be present in addition to the cubic YAG phase.

In the process according to the invention, the nitrates of yttrium, aluminium and cerium, inter alia, are used as starting materials for the thermal treatment in the pulsation reactor. In this case, the Y₃Al₅O₁₂:Ce phase corresponding to the starting chemical composition is initially not formed, but instead partially amorphous aluminium oxide and a phase mixture of yttrium aluminates in the form of about 90% of YAlO₃ and about 10% of Y₃Al₅O₁₂. Through the thermal aftertreatment according to the invention in the temperature range from 900° C. to 1200° C., preferably 1100° C., the material can be completely converted into the cubic YAG phase. This is necessary in particular for use as garnet phosphor.

Surprisingly, it has been found that complete conversion of the powder obtained from the pulsation reactor to cubic Y₃Al₅O₁₂ (YAG) is achieved even at 1100° C., although higher aftertreatment temperatures are preferred for better healing of the lattice structure.

In particular in order to build up the cubic YAG lattice and to obtain the +III oxidation state of the cerium, subsequent thermal treatment, preferably in a reducing atmosphere (for example forming gas, hydrogen or carbon monoxide) is necessary after the reaction in the pulsation reactor. This is preferably a one- or multistep thermal aftertreatment in the temperature range from 600 to 1800° C., preferably 1200 to 1700° C. This thermal aftertreatment particularly preferably consists of a two-step process, where the first process represents shock heating at temperature T₁ and the second process represents a conditioning process at temperature T₂. The shock heating can be initiated, for example, by introducing the sample to be heated into the furnace which has already been heated to T₁. T₁ here is 1000 to 1800° C., preferably 1200 to 1600° C., and the values for T₂ are between 1000 and 1800° C., preferably 1600 to 1700° C. The first process of shock heating takes place over a period of 1-2 h. The material can then be cooled to room temperature and finely ground. The conditioning process at T₂ takes place over a period of 2 to 8 hours.

This two-step thermal aftertreatment has the advantage that the partially crystalline or amorphous finely divided, surface-reactive powder coming out of the pulsation reactor is subjected, in the first step at temperature T₁, to partial sintering and, in a downstream thermal step at T₂, particle growth is significantly restricted by sintering, but complete crystallisation and/or phase conversion takes place or crystal defects are thermally healed.

A further process variant according to the invention consists in one or more fluxing agents, such as, for example, ammonium fluoride, optionally additionally being added in order to lower the melting point before the thermal aftertreatment.

The invention furthermore relates to a garnet phosphor based on (Y, Gd, Lu, Tb)₃ (Al, Ga)₅O₁₂:Ce and mixtures thereof, obtainable by the process according to the invention.

The garnet phosphor preferably has an average particle size in the range from 50 nm to 20 μm, preferably 500 nm to 5 μm, a specific surface area (by the BET method) in the range 1-14 m²/g, preferably 4-10 m²/g, and a non-porous, spherical morphology. Non-porous in this sense means surfaces which have no mesopores (diameter 2-50 nm) and macropores (diameter>50 nm). As already mentioned above, a non-porous morphology or the smallest possible surface area of the phosphors is important in order to minimise reflection and scattering at the powder surface.

The present invention furthermore relates to mixtures of the garnet phosphor according to the invention and one or more components from the following series:

SrAl₂O₄:Eu, Sr₄Al₁₄O₂₅:Eu, (Ca, Sr, Ba)S:Eu, (Ca, Sr, Ba)(Ga, Al, Y)₂S₄:Eu, (Ca, Sr, Ba) Si₂N₂O₂:Eu, SrSiAl₂O₃N₂:Eu, (Ca, Sr, Ba)₂Si₅N₈:Eu and/or CaAlSiN₃:Eu.

By mixing the garnet phosphors according to the invention with the phosphors mentioned, it is possible to generate flexibly artificial light by means of a combination of a primary light source with the phosphor mixture. The spectral properties of this light can be adjusted and matched to the requirements of the particular application, in particular with respect to light-technical parameters, such as the colour temperatures and the colour reproduction value, by variation of the composition of the phosphor mixture.

The present invention furthermore relates to an illumination unit having at least one primary light source comprising at least one garnet phosphor according to the invention.

The primary light source of the illumination unit preferably has an emission maximum in the range from 340 to 510 nm, where the primary radiation is converted completely or partially into longer-wavelength radiation by the garnet phosphors according to the invention.

In a preferred embodiment of the illumination unit according to the invention, the light source is a luminescent indium aluminium gallium nitride, in particular of the formula InᵢGaⱼAlₖN, where 0≦i, 0≦j, 0≦k, and i+j+k=1.

In a further preferred embodiment of the illumination unit according to the invention, the light source is a luminescent compound based on ZnO, TCO (transparent conducting oxide), ZnSe or SiC or a material based on an organic light-emitting layer.

In a further preferred embodiment of the illumination unit according to the invention, the light source is a source which exhibits electroluminescence and/or photoluminescence. The light source may furthermore also be a plasma or discharge source.

The phosphors according to the invention may either be dispersed in a resin (for example epoxy or silicone resin) or, in the case of suitable parameter ratios, arranged directly on the primary light source or alternatively arranged remote therefrom, depending on the application (the latter arrangement also includes “remote phosphor technology”). The advantages of “remote phosphor technology” are known to the person skilled in the art and are revealed, for example, by the following publication: Japanese Journ. of Appl. Phys. Vol. 44, No. 21 (2005). L649-L651.

In a further embodiment, it is preferred for the optical coupling of the illumination unit between the phosphor and the primary light source to be achieved by a light-conducting arrangement. This enables the primary light source to be installed at a central location and optically coupled to the phosphor by means of light-conducting devices, such as, for example, light-conducting fibres. In this way, lights matched to the illumination wishes and merely consisting of one or different phosphors, which may be arranged to form a viewing screen, and a light conductor, which is coupled to the primary light source, can be achieved. In this way, it is possible to position a strong primary light source at a location which is favourable for the electrical installation and to install lights comprising phosphors which are coupled to the light conductors at any desired locations without further electrical cabling, but instead only by laying light conductors.

The following examples are intended to illustrate the present invention. However, they should in no way be regarded as limiting. All compounds or components which can be used in the compositions are either known and commercially available or can be synthesised by known methods. The temperatures indicated in the examples are always in ° C. It furthermore goes without saying that, both in the description and also in the examples, the added amounts of the components in the compositions always add up to a total of 100%. The percentage data given should always be regarded in the given connection. However, they usually always relate to the weight of the part or total amount indicated.

### EXAMPLES

### Example 1

### Preparation of an Aqueous Precursor of the Phosphor (Y_{0.98}Ce_{0.02)}₃Al₅O₁₂ by Coprecipitation

2.94 l of 0.5 M Y(NO₃)₃.6H₂O solution, 60 ml of 0.5 M Ce(NO₃)₃.6H₂O solution and 5 l of 0.5 M Al(NO₃)₃.9H₂O are introduced into a dispensing vessel. The combined solutions are metered slowly with stirring into 8 l of a 2 M ammonium hydrogencarbonate solution which had previously been adjusted to pH 8-9 using NH₃ solution.

During the metered addition of the acidic nitrate solution, the pH must be kept at 8-9 by addition of ammonia. After about 30-40 minutes, the entire solution should have been added, with a flocculant, white precipitate forming. The precipitate is allowed to age for about 1 h and is then kept in suspension by stirring.

### Example 2

### Preparation of an Alcoholic Precursor of the Phosphor (Y_{0.98}Ce_{0.02})₃Al₅O₁₂ by Coprecipitation

2.94 l of 0.5 M Y(NO₃)₃.6H₂O solution, 60 ml of 0.5 M Ce(NO₃)₃.6H₂O solution and 5 l of 0.5 M Al(NO₃)₃.9H₂O are introduced into a dispensing vessel. The combined solutions are metered slowly with stirring into 8 l of a 2 M ammonium hydrogencarbonate solution which had previously been adjusted to pH 8-9 using NH₃ solution.

During the metered addition of the acidic nitrate solution, the pH must be kept at 8-9 by addition of ammonia. After about 30-40 minutes, the entire solution should have been added, with a flocculant, white precipitate forming. The precipitate is allowed to age for about 1 h. The precipitate is then filtered off and washed a number of times with water and dried at 150° C. before being dispersed in 8 l of ethanol and kept in suspension by stirring.

### Example 3

### Preparation of an Aqueous Precursor of the Phosphor Y_{2.541}Gd_{0.450}Ce_{0.009}Al₅O₁₂ by Coprecipitation

0.45 mol of Gd(NO₃)₃*6H₂O, 2.54 mol of Y(NO₃)₃*6H₂O (M=383.012 g/mol), 5 mol of Al(NO₃)₃*9H₂O (M=375.113) and 0.009 mol of Ce(NO₃)₃*6H₂O are dissolved in 8.2 l of dist. water. This solution is metered dropwise into 16.4 l of an aqueous solution of 26.24 mol of NH₄HCO₃ (having M=79.055 g/mol, m=2740 g) at room temperature with constant stirring. When the precipitation is complete, the precipitate is aged for one hour with stirring. The precipitate is kept in suspension by stirring. After filtration, the filter cake is washed with water and then dried at 150° C. for a few hours.

### Example 4

### Preparation of an Alcoholic Precursor of the Phosphor Y_{2.541}Gd_{0.450}Ce_{0.009}Al₅O₁₂ by Coprecipitation

0.45 mol of Gd(NO₃)₃*6H₂O, 2.541 mol of Y(NO₃)₃*6H₂O (M=383.012 g/mol), 5 mol of Al(NO₃)₃*9H₂O (M=375.113) and 0.009 mol of Ce(NO₃)₃*6H₂O are dissolved in 8.2 l of dist. water. This solution is metered dropwise into 16.4 l of an aqueous solution of 26.24 mol of NH₄HCO₃ (having M=79.055 g/mol, m=2740 g) at room temperature with constant stirring. When the precipitation is complete, the precipitate is aged for one hour with stirring. The precipitate is kept in suspension by stirring. After filtration, the filter cake is washed with water and then dried at 150° C. for a few hours and re-dispersed in ethanol and kept in suspension by stirring.

### Example 5

### Preparation of an Aqueous Precursor of the Phosphor Y_{2.88}Ce_{0.12}Al₅O₁₂ by the Peccini Process

2.88 mol of Y(NO₃)₃*6H₂O, 5 mol of Al(NO₃)₃*9H₂O (M=375.113) and 0.12 mol of Ce(NO₃)₃*6H₂O are dissolved in 3280 ml of dist. water. This solution is added dropwise at room temperature with stirring to a precipitation solution consisting of 246 g of citric acid in 820 ml of ethylene glycol, and the mixture is stirred until the dispersion becomes transparent.

### Example 6

### Preparation of an Alcoholic Precursor of the Phosphor Y_{2.88}Ce_{0.12}Al₅O₁₂ by the Peccini Process

2.88 mol of Y(NO₃)₃*6H₂O, 5 mol of Al(NO₃)₃*9H₂O (M=375.113) and 0.12 mol of Ce(NO₃)₃*6H₂O are dissolved in 3280 ml of dist. water. This solution is added dropwise at room temperature with stirring to a precipitation solution consisting of 246 g of citric acid in 820 ml of ethylene glycol, and the mixture is stirred until the dispersion becomes transparent. The dispersion is then heated to 200° C., during which the viscosity increases and finally precipitation or turbidity occurs. After the precipitate has been filtered off and dried at 100° C., it is dispersed in ethanol and kept in suspension.

### Example 7

### Preparation of an Aqueous Precursor of the Phosphor Y_{2.541}Gd_{0.450}Ce_{0.009}Al₅O₁₂ by the Peccini Process

0.45 mol of Gd(NO₃)₃*6H₂O, 2.541 mol of Y(NO₃)₃*6H₂O (M=383.012 g/mol), 5 mol of Al(NO₃)₃*9H₂O (M=375.113) and 0.009 mol of Ce(NO₃)₃*6H₂O are dissolved in 3280 ml of dist. water. This solution is added dropwise at room temperature with stirring to a precipitation solution consisting of 246 g of citric acid in 820 ml of ethylene glycol, and the mixture is stirred until the dispersion becomes transparent. The dispersion is then heated to 200° C., during which the viscosity increases and finally precipitation or turbidity occurs.

### Example 8

### Preparation of an Alcoholic Precursor of the Phosphor Y_{2.541}Gd_{0.450}Ce_{0.009}Al₅O₁₂ by the Peccini Process

0.45 mol of Gd(NO₃)₃*6H₂O, 2.54 mol of Y(NO₃)₃*6H₂O (M=383.012 g/mol), 5 mol of Al(NO₃)₃*9H₂O (M=375.113) and 0.009 mol of Ce(NO₃)₃*6H₂O are dissolved in 3280 ml of dist. water. This solution is added dropwise at room temperature with stirring to a precipitation solution consisting of 246 g of citric acid in 820 ml of ethylene glycol, and the mixture is stirred until the dispersion becomes transparent. The dispersion is then heated to 200° C., during which the viscosity increases and finally precipitation or turbidity occurs. After the precipitate has been filtered off and dried at 100° C., it is dispersed in ethanol and kept in suspension.

### Example 9

### Preparation of an Aqueous Precursor of the Phosphor Y_{2.94}Al₅O₁₂:Ce_{0.06} by the Combustion Method Using Urea

2.94 mol of Y(NO₃)₃*6H₂O, 5 mol of Al(NO₃)₃*9H₂O (M=375.113) and 0.06 mol of Ce(NO₃)₃*6H₂O are dissolved in 3280 ml of dist. water and boiled under reflux. 8.82 mol of urea are added to the boiling solution. On further boiling and finally partial evaporation, a fine, opaque white foam forms. This is dried at 100° C., finely ground, re-dispersed in water and kept in suspension.

### Example 10

### Preparation of an Alcoholic Precursor of the Phosphor Y_{2.94}Al₅O₁₂:Ce_{0.06} by the Combustion Method Using Urea

2.94 mol of Y(NO₃)₃*6H₂O, 5 mol of Al(NO₃)₃*9H₂O (M=375.113) and 0.06 mol of Ce(NO₃)₃*6H₂O are dissolved in 3280 ml of dist. water and boiled under reflux. 8.82 mol of urea are added to the boiling solution. On further boiling and finally partial evaporation, a fine, opaque white foam forms. This is dried at 100° C., finely ground, then dispersed in ethanol and kept in suspension.

### Example 11

### Preparation of an Aqueous Precursor of the Phosphor Y_{2.541}Gd_{0.450}Ce_{0.009}Al₅O₁₂ by the Combustion Method Using Urea

0.45 mol of Gd(NO₃)₃*6H₂O, 2.54 mol of Y(NO₃)₃*6H₂O (M=383.012 g/mol), 5 mol of Al(NO₃)₃*9H₂O (M=375.113) and 0.009 mol of Ce(NO₃)₃*6H₂O are dissolved in 3280 ml of dist. water and boiled under reflux. 8.82 mol of urea are added to the boiling solution. On further boiling and finally partial evaporation, a fine, opaque white foam forms. This is dried at 100° C., finely ground, then re-dispersed in water and kept in suspension.

### Example 12

### Preparation of an Alcoholic Precursor of the Phosphor Y_{2.541}Gd_{0.450}Ce_{0.009}Al₅O₁₂ by the Combustion Method Using Urea

0.45 mol of Gd(NO₃)₃*6H₂O, 2.541 mol of Y(NO₃)₃*6H₂O (M=383.012 g/mol), 5 mol of Al(NO₃)₃*9H₂O (M=375.113) and 0.009 mol of Ce(NO₃)₃*6H₂O are dissolved in 3280 ml of dist. water and boiled under reflux. 8.82 mol of urea are added to the boiling solution. On further boiling and finally partial evaporation, a fine, opaque white foam forms. This is dried at 100° C., finely ground, dispersed in ethanol and kept in suspension.

### Example 13

### Preparation of a Dispersion of the Precursor of the Phosphor Y_{2.541}Gd_{0.450}Ce_{0.009}Al₅O₁₂

A solution comprising aqueous nitrate solutions (firstly prepared separately) and solid nitrates is prepared at a temperature of 40° C.-50° C. This is prepared from 362.9 g of Y(NO₃)₃*6H₂O solution (metal content 14.38%), 656.2 g of Al(NO₃)₃*9H₂O solution (metal content 4.75%), 1.2 g of Ce(NO₃)₃*6H₂O solution (metal content 25.17%) and 46.9 g of Gd(NO₃)₃*6H₂O (metal content 34.85%). Twice the volume of petroleum benzin (boiling fraction 100-140° C., Merck, article number 1.01770.6000) and (based on the petroleum benzin) 5% of an emulsifier (Span 80, Merck, article number 8.40123.1000) and 5% of a dispersion assistant (Span 40, Merck, article number 8.40120.0500) are added to this solution. The mixture is then homogenised ten times at 250 kbar in a Niro/Soavi high-pressure homogeniser.

### Example 14

### Preparation of a Partially Crystalline or Amorphous Precursor Powder of a Garnet Phosphor with the Aid of a Pulsation Reactor

A dispersion from Examples 1-13 is conveyed at a volume flow rate of 3 kg/h with the aid of a hose pump into a pulsation reactor, where it is finely atomised via a 1.8 mm titanium nozzle into the interior of the reactor, where it is thermally treated.

### Reactor Parameters:

Combustion chamber temperature: 1030° C.
Resonance tube temperature: 1136° C.
Ratio of the amount of combustion air to the amount of fuel (natural gas):10:1 (air:gas)

### Example 15

### Thermal Aftertreatment of the Powder from Example 14 in a Stream of Forming Gas in a Furnace

The powder is introduced into a cuboid corundum crucible and placed in a chamber furnace. The calcination material in the furnace is firstly heated to 600° C. in an air atmosphere. Forming gas (comprising 5% of hydrogen) is then passed into the furnace, and the furnace is heated to 1000° C. at the highest possible heating rate. The furnace contents are then cooled to room temperature in the stream of forming gas. The calcined powder is then removed and finely ground using a mortar. The powder is then re-heated to a temperature of 1600° C. in the corundum crucible in the stream of forming gas at the highest possible heating rate and left at this temperature in the stream of forming gas for 8 h, before the sample is cooled to room temperature and removed from the furnace.

### Example 16

### Thermal Aftertreatment of the Powder from Example 14 in Carbon Monoxide in a Furnace

The powder is introduced into a cuboid corundum crucible and placed in a chamber furnace. The calcination material in the furnace is firstly heated to 600° C. in an air atmosphere. The sample is then heated to 1000° C. in carbon monoxide at the highest possible heating rate. The furnace contents are then cooled to room temperature in carbon monoxide. The calcined powder is then removed and finely ground using a mortar. The powder is then re-heated to a temperature of 1600° C. in the corundum crucible in carbon monoxide at the highest possible heating rate and left at this temperature in carbon monoxide for 8 h, before the sample is cooled to room temperature and removed from the furnace.

### Example 17

### Integration of the YAG:Ce Particles Produced [(Y_{0.98}Ce_{0.02})Al₅O₁₂] into a Blue LED

5 g of the YAG:Ce phosphors prepared are finely ground in order to destroy agglomerates. 1 mg of the powder is dispersed in a small amount of silicone oil or epoxy resin, and the mixture is dripped onto the InGaN chip using a micropipette.

### DESCRIPTION OF THE FIGURES

The invention will be explained in greater detail below with reference to a number of working examples.

FIG. 1 shows an SEM overview of a phosphor precursor having the composition Y_{2.541}Ce_{0.009}Gd_{0.45}Al₅O₁₂ prepared as described in Example 13.

FIG. 2 shows an SEM detailed view of the same phosphor precursor as in FIG. 1.

FIG. 3 shows a fluorescence spectrum of the garnet phosphor Y_{2.541}Ce_{0.009}Gd_{0.45}Al₅O₁₂ prepared as described in Examples 13 to 15.

FIG. 4 shows a diagrammatic representation of a light-emitting diode with a phosphor-containing coating. The component comprises a chip-like light-emitting diode (LED) 1 as radiation source. The light-emitting diode is accommodated in a cup-shaped reflector, which is held by an adjustment frame 2. The chip 1 is connected to a first contact 6 via a flat cable 7 and directly to a second electrical contact 6′. A coating which comprises a conversion phosphor according to the invention has been applied to the inside curvature of the reflector cup. The phosphors are either employed separately from one another or in the form of a mixture. (List of part numbers: 1 light-emitting diode, 2 reflector, 3 resin, 4 conversion phosphor, 5 diffuser, 6 electrodes, 7 flat cable)

FIG. 5 shows a COB (chip on board) package of the InGaN type which serves as light source (LED) for white light (1=semiconductor chip; 2, 3=electrical connections; 4=conversion phosphor; 7=board). The phosphor is distributed in a binder lens, which at the same time represents a secondary optical element and influences the light emission characteristics as a lens.

FIG. 6 shows a COB (chip on board) package of the InGaN type which serves as light source (LED) for white light (1=semiconductor chip; 2, 3=electrical connections; 4=conversion phosphor; 7=board). The phosphor is located in a thin binder layer distributed directly on the LED chip. A secondary optical element consisting of a transparent material can be placed thereon.

FIG. 7 shows a package which serves as light source (LED) for white light (1=semiconductor chip; 2, 3=electrical connections; 4=conversion phosphor in cavity with reflector). The conversion phosphor is dispersed in a binder, where the mixture fills the cavity.

FIG. 8 shows a package, where 1=housing; 2=electrical connection; 3=lens; 4=semiconductor chip. This design has the advantage of being a flip chip design, where a greater proportion of the light from the chip can be used for light purposes via the transparent substrate and a reflector on the base. In addition, heat dissipation is favoured in this design.

FIG. 9 shows a package, where 1=housing; 2=electrical connection; 4=semiconductor chip, and the cavity below the lens is completely filled with the conversion phosphor according to the invention. This package has the advantage that a greater amount of the conversion phosphor can be used. This can also act as remote phosphor.

FIG. 10 shows an SMD (surface mounted package), where 1=housing; 2, 3=electrical connections, 4=conversion layer. The semiconductor chip is completely covered by the phosphor according to the invention. The SMD design has the advantage that it has a small physical shape and thus fits into conventional lights.

FIG. 11 shows a T5 package, where 1=conversion phosphor; 2=chip; 3, 4=electrical connections; 5=lens with transparent resin. The conversion phosphor is located on the reverse of the LED chip, which has the advantage that the phosphor is cooled via the metallic connections.

FIG. 12 shows a diagrammatic representation of a light-emitting diode where 1=semiconductor chip; 2, 3=electrical connections; 4=conversion phosphor; 5=bond wire, where the phosphor is applied as top globe in a binder. This form of the phosphor/binder layer can act as secondary optical element and influence, for example, the light propagation.

FIG. 13 shows a diagrammatic representation of a light-emitting diode where 1=semiconductor chip; 2, 3=electrical connections; 4=conversion phosphor; 5=bond wire, where the phosphor is applied as a thin layer dispersed in a binder. A further component acting as secondary optical element, such as, for example, a lens, can easily be applied to this layer.

FIG. 14 shows an example of a further application, as is already known in principle from U.S. Pat. No. 6,700,322. Here, the phosphor according to the invention is used together with an OLED. The light source is an organic light-emitting diode 31, consisting of the actual organic film 30 and a transparent substrate 32. The film 30 emits, in particular, blue primary light, generated, for example, by means of PVK:PBD:coumarine (PVK, abbreviation for poly(n-vinylcarbazole); PBD, abbreviation for 2-(4-biphenyl)-5-(4-tert-butylphenyl)-1,3,4-oxadiazole). The emission is partially converted into yellow, secondarily emitted light by a top layer formed from a layer 33 of the phosphor according to the invention, so that white emission is achieved overall by colour mixing of the primarily and secondarily emitted light. The OLED essentially consists of at least one layer of a light-emitting polymer or of so-called small molecules between two electrodes which consist of materials known per se, such as, for example, ITO (abbreviation for indium tin oxide), as anode and a highly reactive metal, such as, for example, Ba or Ca, as cathode. A plurality of layers, which either serve as hole-transport layers or also as electron-transport layers in the region of the small molecules, are frequently also used between the electrodes. The emitting polymers used are, for example, polyfluorenes or polyspiro materials.

FIG. 15 shows a low-pressure lamp 20 with a mercury-free gas filling 21 (diagrammatic), which comprises an indium filling and a buffer gas analogously to WO 2005/061659, where a layer 22 of the phosphors according to the invention has been applied.

FIG. 16 shows a sketch of the principle of the pulsation reactor.

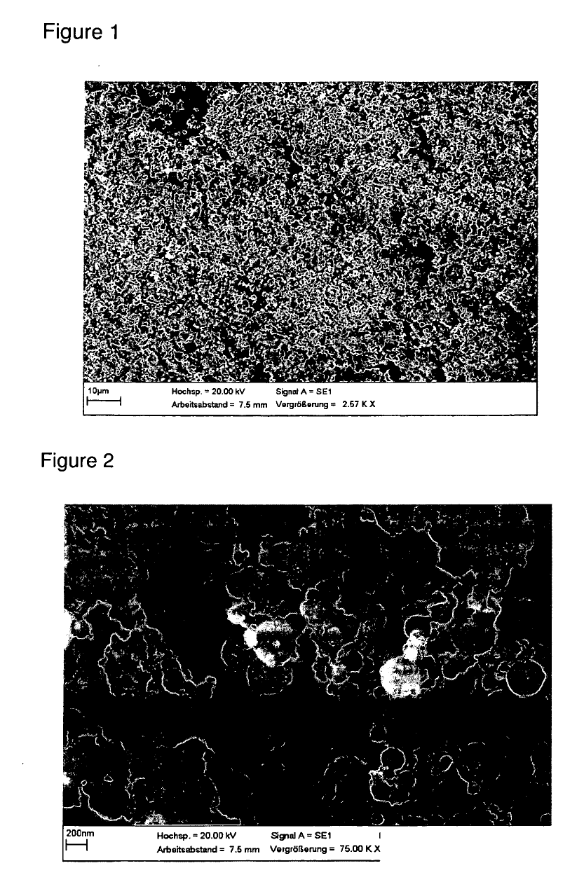

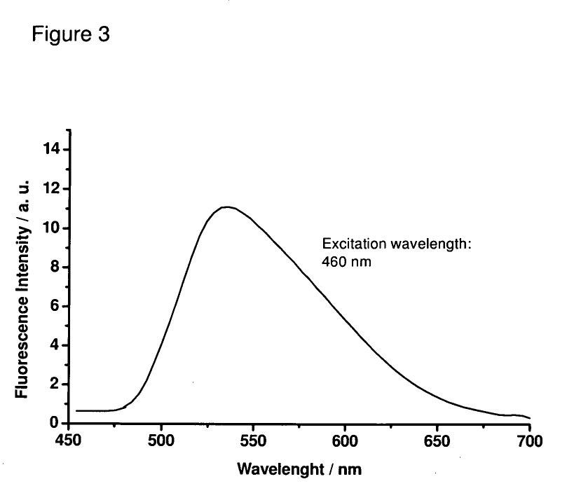

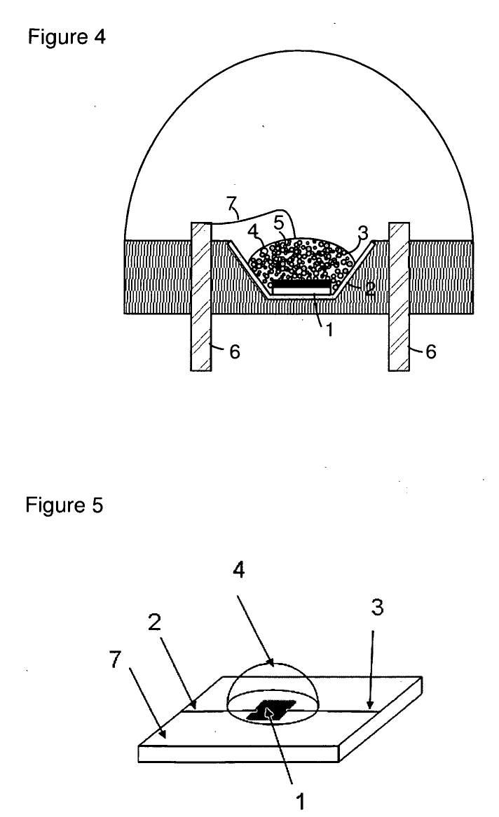

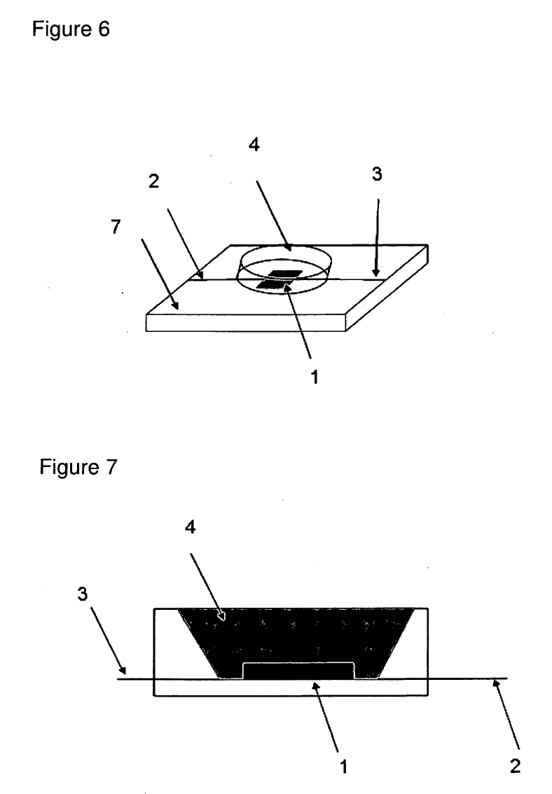

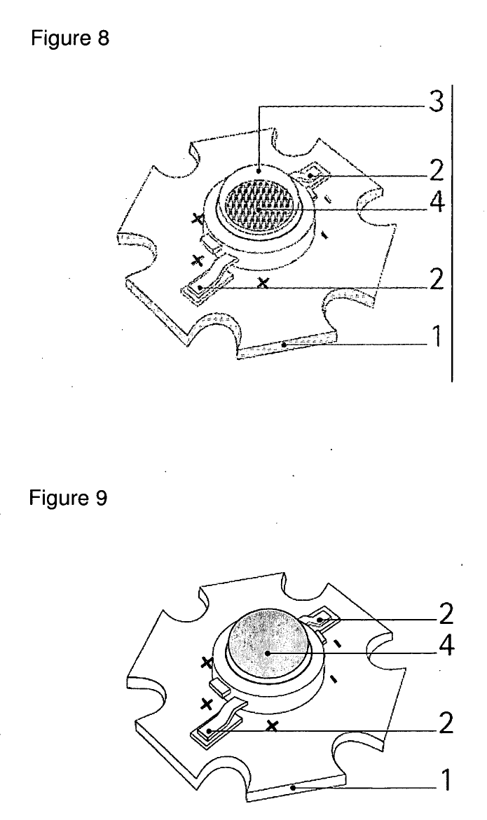

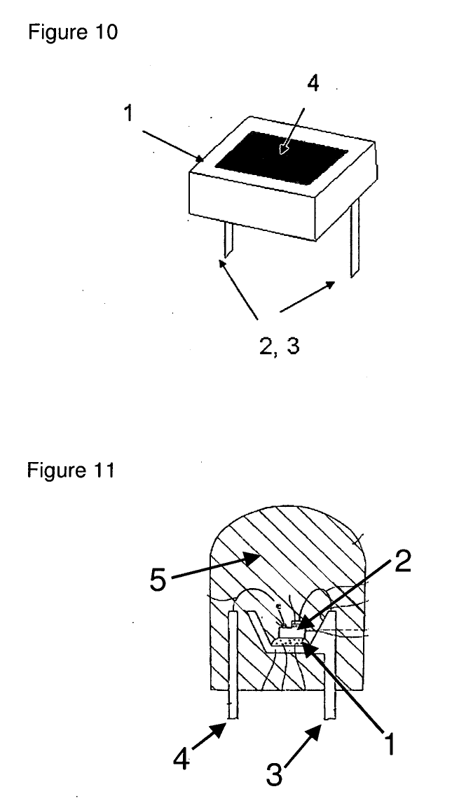

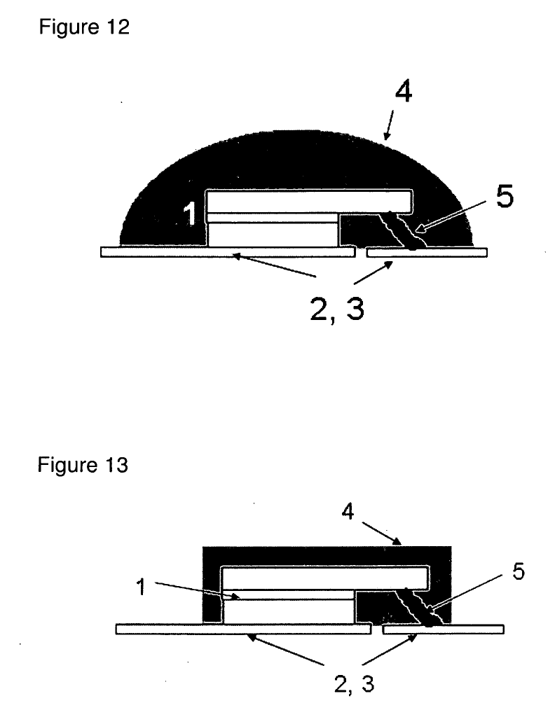

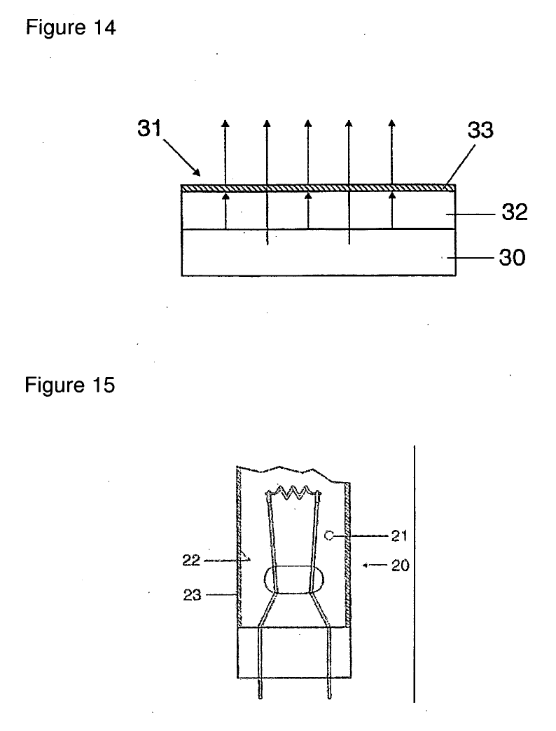

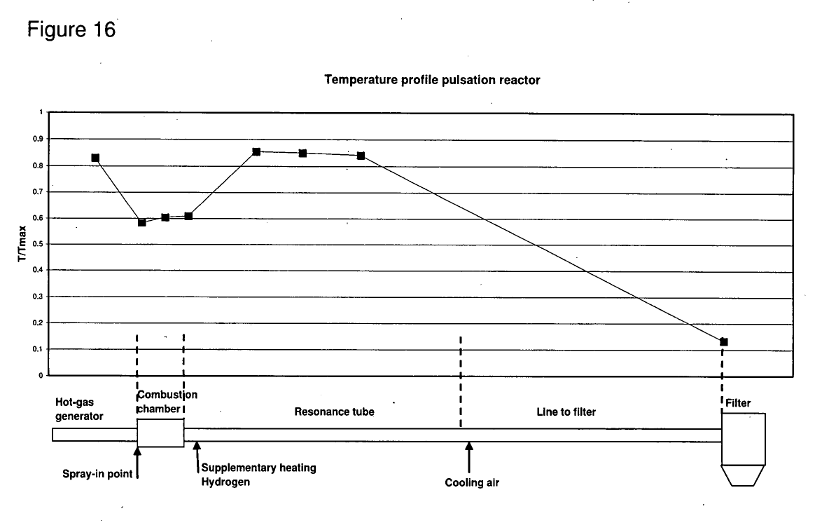

1. Process for the preparation of garnet phosphors doped with rare earths or precursors thereof having particles with an average particle size of 50 nm to 20 μm via a multistep thermal process, characterised in that a mixture in the form of a solution, suspension or dispersion which comprises all components for the preparation of the garnet phosphors is sprayed by fine atomisation into a thermal reactor, where the hot-gas stream of the reactor is produced by pulsating combustion of fuel gas/air mixture, where the temperature at the spray-in point in the thermal reactor is 500-1500° C., preferably 800-1300° C., where the thermal treatment of the mixture in the thermal reactor can optionally be combined with additional feed of fuel in the thermal reactor at a site which is behind the spray-in point relative to the hot-gas stream at a downstream site, and an additional thermal aftertreatment takes place in the same and/or a different thermal reactor.

2. Process according to claim 1, characterised in that the starting materials used or the mixture are inorganic and/or organic substances, such as nitrates, carbonates, hydrogencarbonates, carboxylates, alcoholates, acetates, oxalates, citrates, halides, sulfates, organometallic compounds, hydroxides and/or oxides of Al, Y, Gd, Tb, Ga, Lu, Pr, Tb, Ga, Eu and/or Ce, which are dissolved and/or suspended in inorganic and/or organic liquids.

3. Process according to claim 1, characterised in that one or more inorganic substances may be added to the mixture to be sprayed.

4. Process according to claim 1, characterised in that the additionally added substance is a nitrate, preferably NH₄NO₃, and in that the amount added is 10 to 80%, preferably 25 to 50%, based on the amount of starting material employed.

5. Process according to claim 1, characterised in that one or more surfactants and/or emulsifiers are added to the mixture to be sprayed.

6. Process according to claim 1, characterised in that the surfactant employed is a fatty alcohol ethoxylate in an amount of 1 to 10% by weight, preferably 3 to 6%, based on the total amount of solution.

7. Process according to claim 1, characterised in that one or more liquid components which are immiscible with the mixture prepared are additionally added to this mixture, and this mixture is dispersed to give droplets by means of mechanical shear forces and stabilised by means of assistants.

8. Process according to claim 1, characterised in that a petroleum benzin having a boiling range of 80-180° C. is used in combination with emulsifiers.

9. Process according to claim 1, characterised in that the emulsifiers used are sorbitan fatty acid derivatives and mixtures thereof having various HLB (hydrophilic-lipophilic balance) values.

10. Process according to claim 1, characterised in that the emulsifiers used are a mixture of fatty acid sorbitan esters and a random copolymer containing at least one monomer having a hydrophilic side chain and at least one monomer having a hydrophobic side chain and a molecular weight between 1000 and 50,000, preferably between 2000 and 20,000.

11. Process according to claim 1, where the random copolymer used is a copolymer of the general formula I 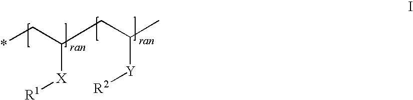
in which the radicals X and Y correspond to conventional nonionic or ionic monomers, and
R¹ denotes hydrogen or a hydrophobic side group, selected from branched and unbranched alkyl radicals having at least four carbon atoms in which one or more H atoms may be replaced by fluorine atoms, and, independently of R¹, R² stands for a hydrophilic side group, which has a phosphonate, sulfonate, polyol or polyether radical.

12. Process according to claim 1, characterised in that the gas stream in the pulsation reactor resulting from the pulsating combustion pulses at 3 to 150 Hz, in particular at 10 to 70 Hz.

13. Process according to claim 1, characterised in that the addition of additional fuel in the form of a fuel gas/air mixture takes place after a residence time of the substances in the reactor of 20-40%, preferably 30%, of the total residence time.

14. Process according to claim 1, characterised in that the garnet phosphor is subjected to a single- or multistep thermal aftertreatment in the temperature range from 600 to 1800° C., preferably from 1200 to 1700° C., after the thermal treatment in the pulsation reactor.

15. Process according to claim 1, characterised in that the single- or multistep thermal aftertreatment is carried out in a thermal reactor, such as a pulsation reactor or rotary tube furnace, or in a fluidised-bed reactor, or in various reactors.

16. Process according to claim 1, characterised in that the thermal aftertreatment proceeds under reducing conditions.

17. Process according to claim 1, characterised in that the thermal aftertreatment consists of a two-step shock heating, where the temperature T₁ in the first step is different from the temperature T₂ in the second step.

18. Process according to claim 1, characterised in that one or more fluxing agents, such as NH₄F, may additionally be added in order to lower the melting point before the thermal aftertreatment.

19. Garnet phosphor based on (Y, Gd, Lu, Tb)₃ (Al, Ga)₅O₁₂:Ce and mixtures thereof, obtainable by a process according to claim 1.

20. Garnet phosphor according to claim 19, characterised in that it has an average particle size in the range from 50 nm to 20 μm, preferably 500 nm to 5 μm, a specific surface area (by the BET method) in the range 1-14 m²/g, preferably 4-10 m²/g, and a non-porous morphology.

21. Mixtures of a garnet phosphor according to claim 19 and one or more components from the following series: SrAl₂O₄:Eu, Sr₄Al₁₄O₂₅:Eu, (Ca, Sr, Ba)S:Eu, (Ca, Sr, Ba)(Ga, Al, Y)₂S₄:Eu, (Ca, Sr, Ba) Si₂N₂O₂:Eu, SrSiAl₂O₃N₂:Eu, (Ca, Sr, Ba)₂Si₅N₈:Eu and/or CaAlSiN₃:Eu.

22. Illumination unit having at least one primary light source comprising at least one garnet phosphor according to claim 19.

23. Illumination unit according to claim 22, characterised in that the emission maximum of the primary light source is in the range from 340 to 510 nm, where the radiation is partially or completely converted into longer-wavelength radiation by garnet phosphors.

24. Illumination unit according to claim 22, characterised in that the light source is a luminescent indium aluminium gallium nitride, in particular of the formula InᵢGaⱼAlₖN, where 0≦i, 0≦j, 0≦k, and i+j+k=1.

25. Illumination unit according to claim 22, characterised in that the light source is a luminescent compound based on ZnO, TCO (transparent conducting oxide), ZnSe or SiC.

26. Illumination unit according to claim 22, characterised in that the light source is a material based on an organic light-emitting layer.

27. Illumination unit according to claim 22, characterised in that the light source is a source which exhibits electroluminescence and/or photoluminescence.

28. Illumination unit according to claim 22, characterised in that the light source is a plasma or discharge source.

29. Illumination unit according to claim 22, characterised in that the phosphor is arranged directly on the primary light source and/or remote therefrom.

30. Illumination unit according to claim 22, characterised in that the optical coupling between the phosphor and the primary light source is achieved by a light-conducting arrangement.
